(19) United States
(12) Patent Application Publication
(10) Pub. No.: US 2016/0345776 A1
(43) Pub. Date: Dec. 1, 2016

(54) ENERGY EFFICIENT OPEN PASS THROUGH HOLDING DEVICE

(71) Applicant: ENODIS CORPORATION, New Port Richey, FL (US)

(72) Inventors: Jan CLAESSON, Land O' Lakes, FL (US); Janice M.K. JAFERIAN, Palm Harbor, FL (US)

(21) Appl. No.: 15/167,135

(22) Filed: May 27, 2016

Related U.S. Application Data
(60) Provisional application No. 62/166,971, filed on May 27, 2015.

(51) Int. Cl. A47J 39/00; A47F 10/06

(52) U.S. Cl. CPC A47J 39/006; A47F 10/06

(57) ABSTRACT

A holding device for food products, comprising: a base unit comprising a heating element and a top surface disposed above the heating element, wherein the food products are disposed on the top surface of the base unit; a top portion disposed apart from and above the top surface of the base unit, such that the food products can be disposed between the base unit and the top portion, wherein the top portion comprises at least one selected from the group consisting of: (1) an electrically conductive coating disposed on a bottom surface of the top portion which radiates heat toward the food products, (2) a low emissivity coating on a top surface of the top portion, and (3) downwardly pointing edge portions which extend beyond the dimensions of the base unit, thereby providing for convection capture of heat generated from the base unit as it rises and contacts the top portion; and at least one support post, wherein the support post supports the top portion above the base and provides a conduit or other means by which electrical connectivity is established between the base and the top portion. Alternatively, electrical connectivity may be established at the base of the device. The base may be divided into regions, one or more of which may be independently temperature-controlled.

### CROSS-REFERENCE TO RELATED APPLICATION

The present application claims the benefit of U.S. Provisional Application Ser. No. 62/166,971, filed on May 27, 2015, which is incorporated herein by reference.

### BACKGROUND OF THE DISCLOSURE

1. Field of the Disclosure

The present disclosure relates to holding devices to keep food products warm from the time they are prepared to the time they are served to a customer. More particularly, the present disclosure relates to holding devices with canopies having coatings to provide improved heating.

2. Description of the Related Art

In many fast food applications where food products are prepared, there is a period of time between when the preparation is complete and when the food products are served to a customer. The food products need to be kept warm during this period while maintaining food quality. For example, cooked food should not be dried out due to excessive heating during the time the food product is held in storage.

Current devices used for this purpose are unsatisfactory, as they use a significant amount of power and/or have very hot surfaces or lamps that are dangerous for users. Furthermore, food quality in conventional storage units is often degraded as the cooked food dries out (i.e., loses moisture) under heating lamps or on top of a heated surfaces, if the storage device temperatures are not carefully regulated. Further, most food holding/storage devices do not have separately controlled heated zones or regions so that all food products are held at the same temperature, regardless of the type of food. This can result in some foods being overheated and others being under-heated. Chicken, for example needs to be held at a higher temperature than fish. If fish is held at too high a temperature, it overcooks, dries out and overall suffers texture impairment. In any case, food quality degrades and may even become unsafe while within a food storage device, whether or not there are controls to modulate the holding/storage temperature. The present disclosure addresses these deficiencies.

### SUMMARY OF THE DISCLOSURE

In one embodiment, the present disclosure provides a holding device for food products, comprising: a base comprising a heating element and a top surface, wherein the food products are on the top surface of the base; a canopy above the top surface of the base, such that the food products can be between the base unit and the canopy, wherein the canopy comprises an electrically conductive coating on a bottom surface of the canopy, which radiates heat toward the base; and at least one support post, wherein the support post supports the canopy above the base.

In another embodiment, the present disclosure provides a holding device for food products, comprising: a base comprising a heating element and a top surface above the heating element, wherein the food products are on the top surface; a canopy apart from and above the top surface of the base unit, such that the food products are between the base and the canopy, wherein the canopy comprises a low emissivity coating on a top surface of the canopy; and at least one support post, wherein the support post supports the canopy above the base.

In another embodiment, the present disclosure provides a holding device for food products, comprising: a base comprising a heating element and a top surface, wherein the food products are on the top surface of the base unit; a canopy apart from and above the top surface of the base unit, such that the food products are between the base unit and the canopy, wherein the canopy comprises downwardly pointing edge portions which extend beyond the dimensions of the base unit, thereby providing for convection capture of heat generated from the base unit as it rises and contacts the canopy; and at least one support post, wherein the support post supports the canopy above the base.

The holding device further comprises a low emissivity coating on a top surface of the top portion.

The base unit comprises a heated mat or surface. The heating element is electrically connected to a bottom side of the heated mat or surface. The heated mat or surface is formed of a conductive material.

The holding device further comprises a power source in the base, and wherein the power source is in electrical communication with the conductive coating. The conductive coating on the bottom surface of the top portion is electrically connected to the base unit via the at least one support post.

The top portion or canopy can be made of a translucent, transparent, or opaque material. The top portion can include downwardly pointing edge portions, thereby directing heat from the top portion towards the food products. The top portion can also include one or more rotatable edge portions, in whole or in part.

The holding device further comprises at least one support rail or panel disposed about a side edge of the base unit.

The holding device further comprises a moveable or hinged flap disposed about the at least one downwardly pointing edge portion or an entire edge on one or more sides of the holding device canopy.

The base unit may be divided into one or more sections with a partition there between. Each section may be individually temperature-controlled.

In another embodiment, the present disclosure provides a holding device for food products, comprising: a base unit comprising a heating element and a top surface disposed above the heating element, wherein the food products are disposed on the top surface of the base unit; a top portion or canopy disposed apart from and above the top surface of the base unit, such that the food products can be disposed between the base unit and the top portion/canopy, wherein the top portion comprises a low emissivity coating on a top surface of the top portion; and at least one support post, wherein the support post supports the top portion above the base.

In a further embodiment, the present disclosure provides a holding device for food products, comprising: a base unit comprising a heating element and a top surface disposed above the heating element, wherein the food products are disposed on the top surface of the base unit; a top portion disposed apart from and above the top surface or canopy of the base unit, such that the food products can be disposed between the base unit and the top portion/canopy, wherein the top portion comprises downwardly pointing edge portions which extend beyond the dimensions of the base unit, thereby providing for convection capture of heat generated from the base unit as it rises and contacts the top portion; and at least one support post, wherein the support post supports the top portion above the base.

### BRIEF DESCRIPTION OF THE DRAWINGS

FIG. 1 shows a top, perspective view of a holding device of the present disclosure.

FIG. 2a shows an additional top, perspective view of the holding device of FIG. 1.

FIG. 2b shows an exploded view of the holding device of FIG. 2a.

FIG. 3a shows a top, perspective view of a top portion or canopy of the holding device of FIG. 2a.

FIG. 3b shows the coatings that are applied to the top portion or canopy of FIG. 3a.

FIG. 3c shows a side view of the top portion or canopy of FIG. 3a.

FIG. 3d shows a side, cross-sectional view of the top portion or canopy of FIG. 3a, along line B-B of FIG. 3c.

FIG. 3e shows a detailed view of the top portion or canopy of FIG. 3a, according to Detail C of FIG. 3d.

FIG. 4a shows a top, perspective view of a second top portion or canopy of the present disclosure.

FIG. 4b shows a side view of the top portion or canopy of FIG. 4a.

FIG. 4c shows a second side view of the top portion or canopy of FIG. 4a.

FIG. 4d shows a top view of the top portion or canopy of FIG. 4a.

FIG. 5a shows a top, perspective view of a holding device of the present disclosure, using the top portion or canopy of FIG. 4a.

FIG. 5b shows a side view of the holding device of FIG. 5a.

FIG. 5c shows a second side view of the holding device of FIG. 5a.

FIG. 5d shows a top view of the holding device of FIG. 5a.

### DETAILED DESCRIPTION OF THE DISCLOSURE

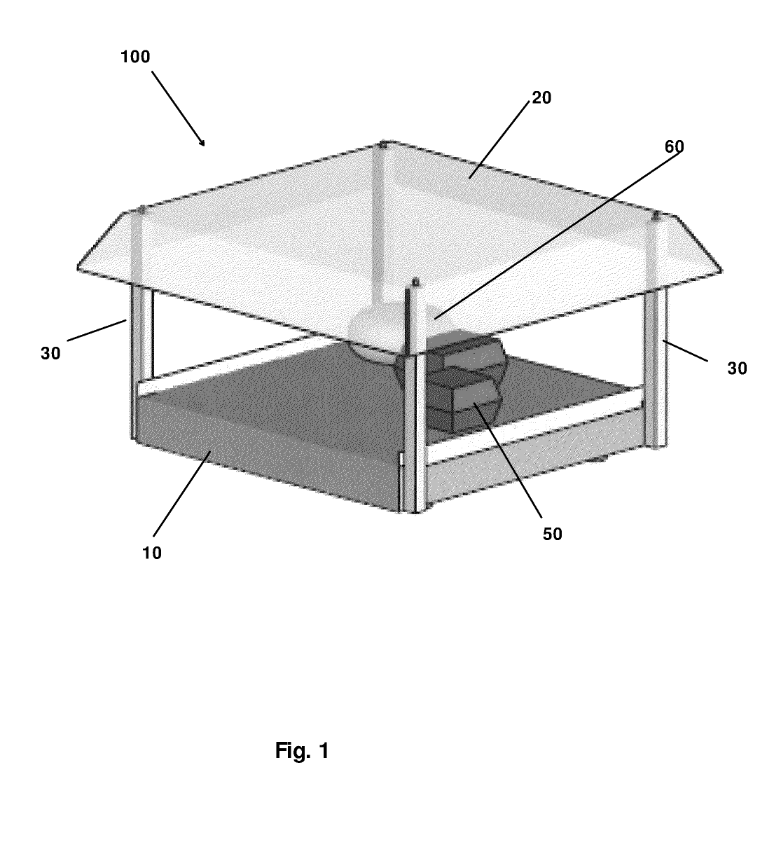

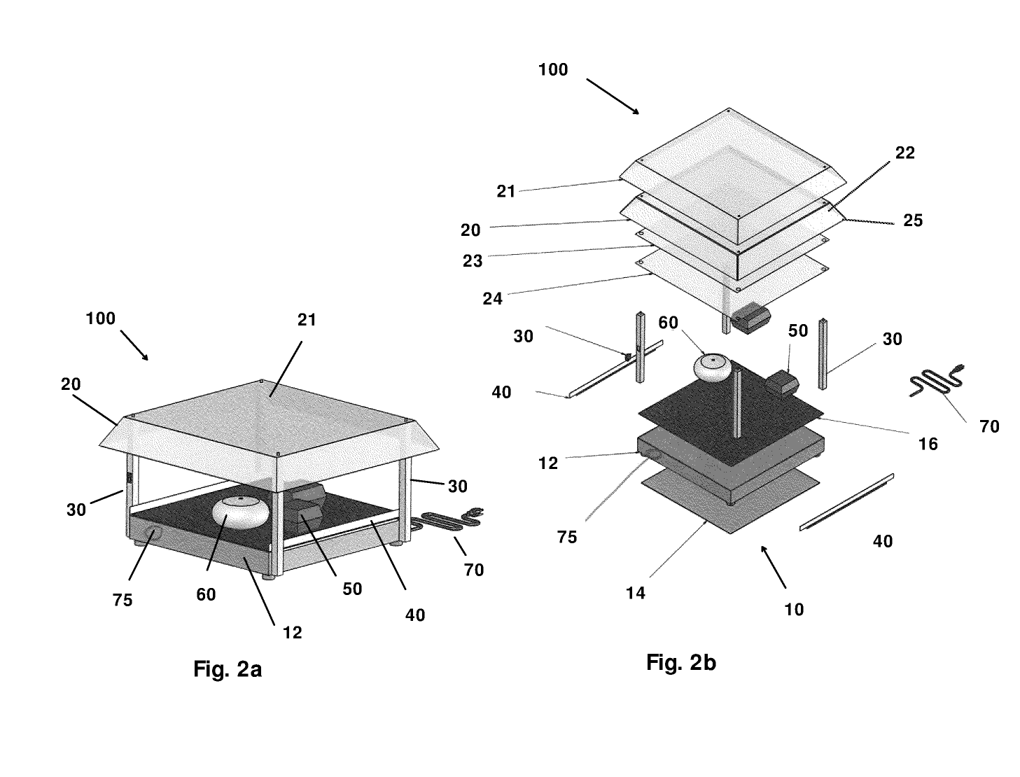

Referring to the Figures, and in particular FIGS. 1-2b, holding device 100 of the present disclosure is shown. Holding device 100 has base 10, a top portion or canopy 20, and one or more support posts 30. As shown in FIG. 1, a boxed food product 50 or wrapped food product 60 can be placed on a top surface 12 of base 10. As discussed in greater detail below, base 10 can have a heating source therein, which warms top surface 12 to keep food products 50 and 60 warm. The spaces between base 10, support post 20, and top portion or canopy 30 are open, to allow an operator or user to easily place and remove food products 50 and 60 from device 100. The term “base” is used to signify a platform, pedestal, or foundation upon which the food products 50, 60 can be placed. The terms “top portion” or “canopy” are used to signify a cover or similar structure that is over the food products on the base.

Furthermore, in some embodiments, top portion or canopy 20 can have a first coating 21 on a top surface 22. Top portion or canopy 20 can also have a heater layer 23 and a second coating 24 on a bottom surface 25. First coating 21 can be of a low-emissivity material, to prevent the loss of heat through the top of top portion or canopy 20. Second under-coating 24 can be of a high-emissivity material. A power source within base 10 can be in electrical communication with heater layer 23 through electrical contacts within support posts 20 or base 10. As discussed in greater detail below, when heater layer 23 is heated, it can provide additional heating to food products 50 and 60 on top surface 12. Each of first coating 21, heater layer 23, and second coating 24 are optional. Furthermore, the low-emissivity coating can be on the bottom or underside surface 25 of top portion or canopy 20.

Thus, holding device 100 provides several advantages not found in currently available devices and methods for keeping food products warm, from the time they are prepared to the time they are served to a customer. Holding device 100 uses much less power than bright heating lamps used elsewhere, yet still maintains ease of access to food products. Further, since the surfaces of device 100 will never be hot enough to be dangerous, device 100 is much safer in the workplace. Device 100 is also much simpler and uses less power than devices that use heated and/or circulated air.

As shown in FIG. 2b, base 10 can have a heated mat or surface 12. A heating element 14 can be connected to a bottom side of mat 12 to provide heating. Heating element 14 may also be embedded within base 10. Mat 12 can be made of a conductive material. Thus, when food products 50 and 60 are placed on mat 12 for temporary storage, they are kept warm. Mat 12 can also have a low thermal conductivity layer or second mat 16 thereon. Layer 16 can protect a user or operator from burns if mat 12 gets too hot.

Heating element 14 can be connected to a power source via plug 70. A temperature control 75 can be on a surface of mat 12, to allow the user to vary the amount of power supplied to heating element 14.

Top portion or canopy 20, first coating 21, and second coating 24 can each be opaque, translucent, or transparent. When these components are transparent or translucent, they provide the advantage of allowing the user to see the food products sitting on mat 12 from the top. As previously discussed, first coating 21, on top surface 22 of top portion or canopy 20, is low-emissivity. This prevents or mitigates the loss of heat out through the top of top portion or canopy 20, increasing the efficiency and efficacy of device 100. Suitable materials for first coating 21 include, but are not limited to, plastic or other thermoplastic polymer.

In the shown embodiment, top portion or canopy 20 has a rectangular shape, with edge portions that are angled down toward base 10. This shape is advantageous for trapping heat that may rise toward top portion or canopy 20 from the food products or base 10. The present disclosure also contemplates that top portion or canopy 20 may be flat or planar. The edge portions of canopy 20, whether angled or planar, can extend beyond the footprint of base 10. That is, looking from the top of device 100, canopy 20 would completely cover base 10. This helps to capture any heat radiating from base 10 within canopy 20. Top portion or canopy 20 may also have other shapes, such as round, elliptical, oval, or others.

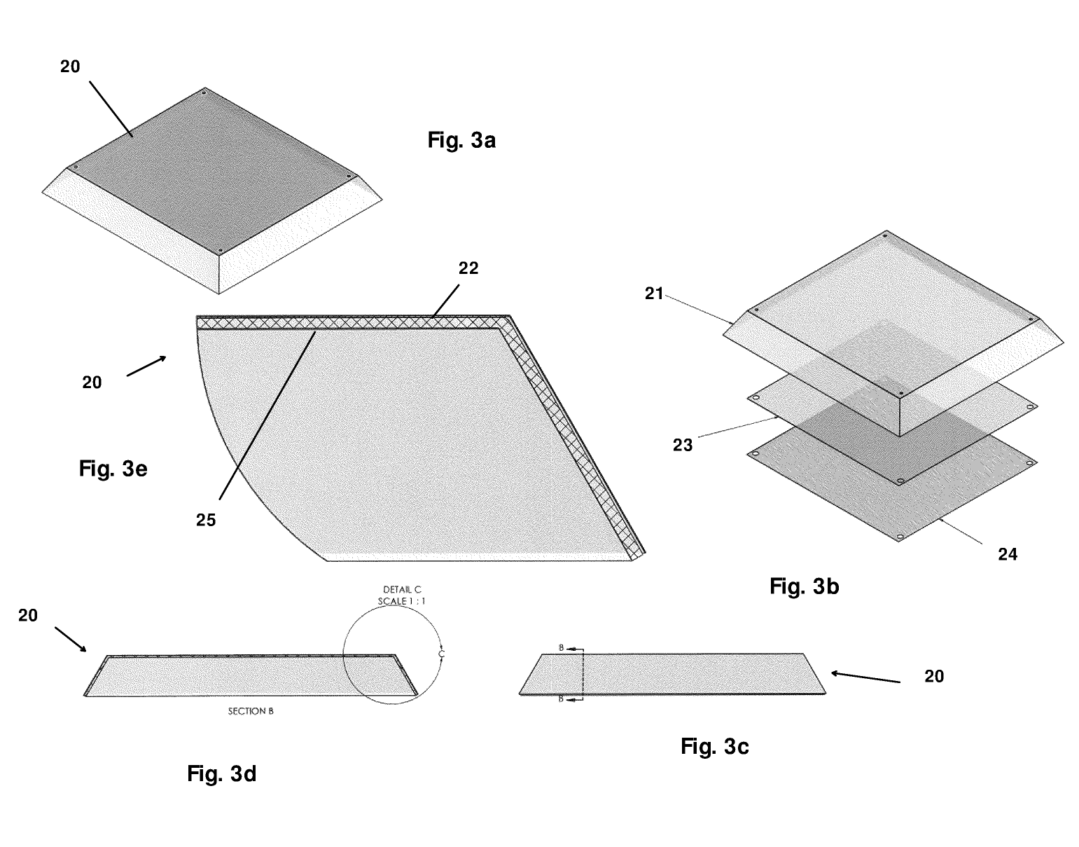

Heating layer 23 can be a coating of a resistive material. Suitable examples of such a material include, but are not limited to, indium oxide or indium-tin oxide. Heating layer 23 may also be made of resistive, conductive metal strips. Second layer 24, made of a high-emissivity material, both protects heater layer 23 and helps to transmit any heat generated by layer 23 toward food products 50 and 60. Suitable materials for second layer 24 include, but are not limited to, plastic or other thermoplastic polymer. As previously discussed, power is supplied to heating layer 23 via contacts hidden in support posts 20 (not shown) or base 10 (not shown). FIGS. 3a-3e show more detailed views of the arrangement of top portion or canopy 20, with first coating 21, outer surface 22, heater layer 23, second coating 24, and lower surface 25. Emissivity values may range between a low of <0.25 and a high of >0.75.

Base 10 may also have one or more guide rails 40, that are connected along external edges of mat 12. Guide rails 40 ensure that food products 50 and 60 do not slide off one or more edges of mat 12.

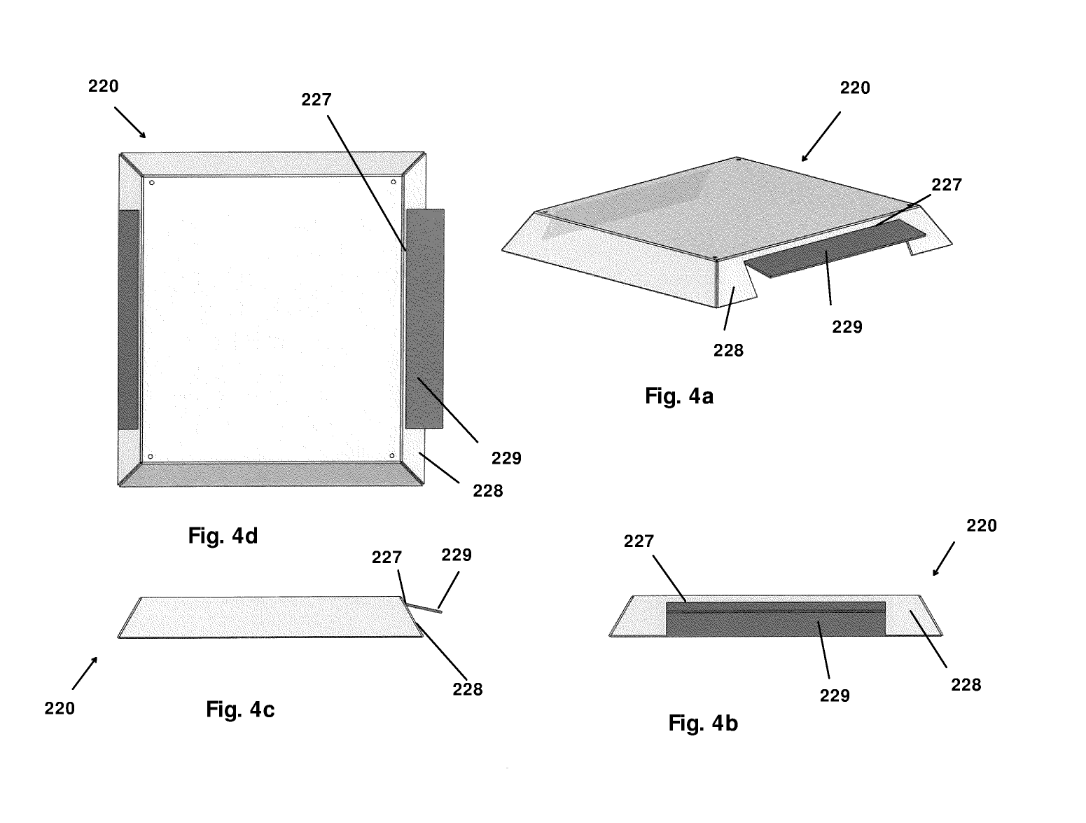

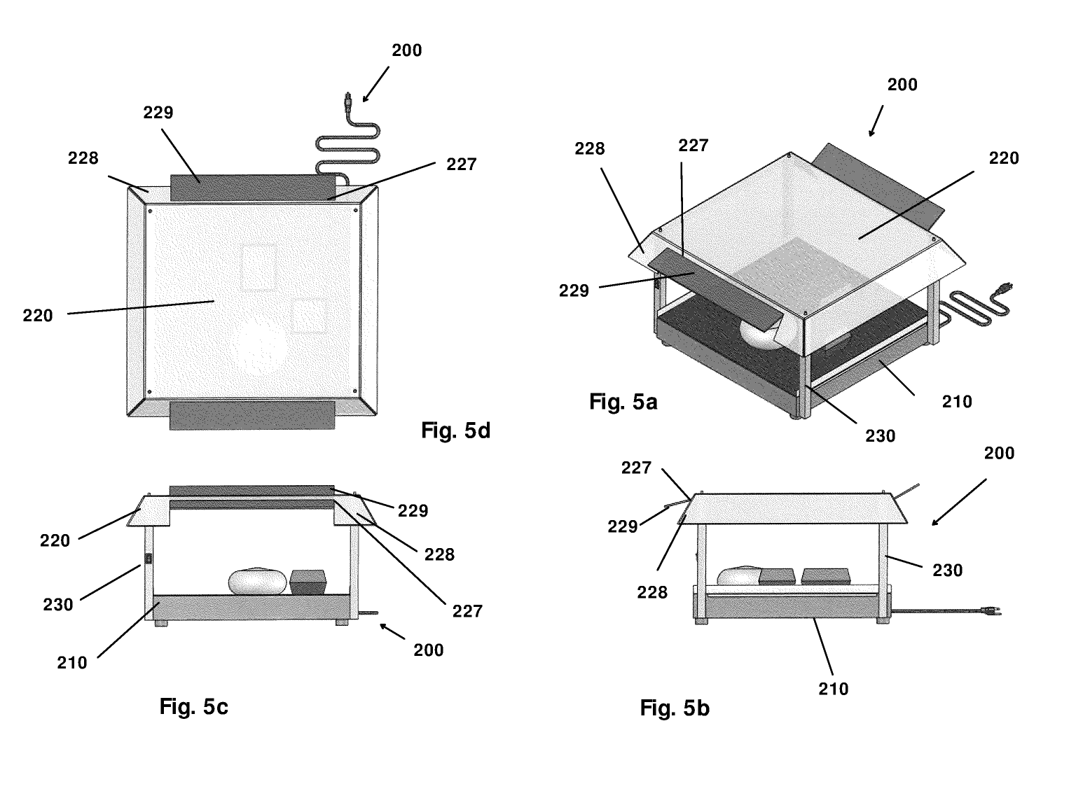

Referring to FIGS. 4a-5d, a second embodiment of the device of the present disclosure is shown, and referred to by numeral 200. Device 200 is virtually identical to device 100, and has base 210, top portion or canopy 220, and one or more support posts 230. Base 210 and post 230 perform identical functions and have identical features to base 10 and posts 30, respectively. In device 200, top portion or canopy 220 has one or more rotatable hinges 227 or other rotatable mechanism and one or more flaps 229 along one or more edge portions 228 or entire edge (not shown). Hinges 227 can rotate or swing bi-directionally to allow easier access to or from the interior space of device 200. In the shown embodiment, there are two hinges 220 on opposite sides of top portion or canopy 220, but the present disclosure contemplates that there can be hinges 227 on one, two, three, or all four sides of top portion or canopy 220. Hinges 227 can also be made to operate bi-directionally, so that the flap 229 swings inwardly when food is placed onto the base 10 of device 100 and outwardly when retrieving food product off the base 10 and outside of the holding device 100. As shown in FIGS. 5a and 5c, a temperature control 275 is on base unit 210, to allow the user to vary the amount of power supplied to heating element, not shown. Device 200 can also have a mat (not shown), that is similar to mat 12 of device 100.

In the shown embodiments, mat 12 is a flat surface. The present disclosure contemplates that mat 12 could be curved, bowl-shaped, or have upturned edges, to more securely hold food products. The surface can be smooth or textured. In addition, different regions of mat 12 can be heated to different temperatures using independent controls or a programmable control system. For example, the edges could be set to a lower temperature, so that operators touching the outer edges of mat 12 are less susceptible to burns. Mat 12 and/or base 10 may also be divided up into distinct regions, with or without physical barriers (similar to guide rails 40) to separate them. Each of these regions could be heated to a different temperature. The temperature can also be turned off entirely, or by zone/region, when the device is not needed in its entirely or in a particular region thereof, then turned on when needed, rapidly heating to the appropriate holding temperature based on the food products to be held and/or the amount of food to be stored any time to meet the demands of the restaurant. This optimizes energy consumption, using less energy when off or only partially on according the usage demand rather than leaving the device on for extended time periods.

In another embodiment (not shown), the base can be divided into one or more sections with a partition between the sections so that various food types can be deposited and held in dedicated sections of the base 10.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A holding device for food products, comprising:
a base comprising a heating element and a top surface, wherein the food products are on the top surface of the base;
a canopy above the top surface of the base, such that the food products can be between the base unit and the canopy, wherein the canopy comprises an electrically conductive coating on a bottom surface of the canopy, which radiates heat toward the base; and
at least one support post, wherein the support post supports the canopy above the base.

2. The holding device according to claim 1, further comprising a low emissivity coating on a top surface of the canopy.

3. The holding device according to claim 1, wherein the base comprises a heated mat on the top surface.

4. The holding device according to claim 3, wherein the heating element is electrically connected to a bottom side of the heated mat.

5. The holding device according to claim 3, wherein the heated mat is made of a conductive material.

6. The holding device according to claim 1, further comprising a power source in the base, and wherein the power source is in electrical communication with the conductive coating of the canopy through electrical connections in the one or more support posts.

7. The holding device according to claim 1, wherein the canopy comprises a translucent, transparent or opaque material.

8. The holding device according to claim 1, wherein the canopy comprises downwardly pointing edge portions, thereby directing heat from the canopy towards the food products.

9. The holding device according to claim 1, wherein the canopy comprises one or more rotatable edge portions.

10. The holding device according to claim 1, further comprising at least one support post at a side edge of the base.

11. The holding device according to claim 1, wherein the canopy is electrically connected to the base via the at least one support post.

12. The holding device according to claim 1, wherein the at least one support rail is a plurality of support posts.

13. The holding device according to claim 8, further comprising a hinged flap on the at least one downwardly pointing edge portions.

14. The holding device according to claim 1, wherein the base is divided into one or more sections with a partition therebetween.

15. A holding device for food products, comprising:
a base comprising a heating element and a top surface above the heating element, wherein the food products are on the top surface;
a canopy apart from and above the top surface of the base unit, such that the food products are between the base and the canopy, wherein the canopy comprises a low emissivity coating on a top surface of the canopy; and
at least one support post, wherein the support post supports the canopy above the base.

16. A holding device for food products, comprising:
a base comprising a heating element and a top surface, wherein the food products are on the top surface of the base unit;
a canopy apart from and above the top surface of the base unit, such that the food products are between the base unit and the canopy, wherein the canopy comprises downwardly pointing edge portions which extend beyond the dimensions of the base unit, thereby providing for convection capture of heat generated from the base unit as it rises and contacts the canopy; and
at least one support post, wherein the support post supports the canopy above the base.
